(19) United States
(12) Patent Application Publication
(10) Pub. No.: US 2025/0341956 A1
(43) Pub. Date: Nov. 6, 2025

(54) ELECTRONIC DEVICE FOR EXECUTING POST-PROCESSING FUNCTION FOR IMAGE, AND METHOD THEREFOR

(71) Applicant: Samsung Electronics Co., Ltd., Suwon-si (KR)

(72) Inventors: Changhoon KANG, Suwon-si (KR); Sunho MOON, Suwon-si (KR); Hyunsuk WON, Suwon-si (KR); Jehan YOON, Suwon-si (KR); Jeaeun JUNG, Suwon-si (KR); Byounggeun CHOI, Suwon-si (KR); Eunnam SONG, Suwon-si (KR)

(21) Appl. No.: 19/271,274

(22) Filed: Jul. 16, 2025

Related U.S. Application Data
(63) Continuation of application No. PCT/KR2023/020576, filed on Dec. 13, 2023.

(30) Foreign Application Priority Data
Jan. 20, 2023 (KR) 10-2023-0009087
Jan. 31, 2023 (KR) 10-2023-0013241

(51) Int. Cl. G06F 3/04845; G06F 3/04817; G06F 3/0482; G06T 5/60; G06T 5/70

(52) U.S. Cl. CPC G06F 3/04845; G06F 3/04817; G06F 3/0482; G06T 5/60; G06T 5/70; G06T 2207/20084; G06T 2207/20182; G06T 2207/20208

(57) ABSTRACT

An electronic device is provided. The electronic device includes a display, memory storing instructions, and one or more processors, wherein the instructions when executed by the one or more processors individually or collectively, cause the electronic device to identify, in response to identifying an input indicating a selection of a first image through the display, a sequence for execution of a post-processing function, change, based on identifying the first image and a second image positioned before the first image in the sequence, a position of the first image within the sequence, and display, based on executing a post-processing function with respect to the first image in accordance with the changed position, the first image changed by the post-processing function in the display.

### CROSS-REFERENCE TO RELATED APPLICATION(S)

This application is a continuation application, claiming priority under 35 U.S.C. § 365(c), of an International application No. PCT/KR2023/020576, filed on Dec. 13, 2023, which is based on and claims the benefit of a Korean patent application number 10-2023-0009087, filed on Jan. 20, 2023, in the Korean Intellectual Property Office, and of a Korean patent application number 10-2023-0013241, filed on Jan. 31, 2023, in the Korean Intellectual Property Office, the disclosure of each of which is incorporated by reference herein in its entirety.

### BACKGROUND

### 1. Field

The disclosure relates to an electronic device for executing a post-processing function with respect to an image, and a method thereof.

### 2. Description of Related Art

An electronic device may obtain an image through a camera. The electronic device may perform image processing with respect to the image obtained through the camera.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the present is to provide an electronic device for executing a post-processing function with respect to an image, and a method thereof.

Additional aspects will be set forth in part in the description which follows and, in part, will be apparent from the description, or may be learned by practice of the presented embodiments.

In accordance with an aspect of the disclosure, an electronic device is provided. The electronic device includes a display, memory storing instructions, and one or more processors, wherein the instructions, when executed by the one or more processors individually or collectively, cause the electronic device to identify, in response to identifying an input indicating a selection of a first image through the display, a sequence for execution of a post-processing function, change, based on identifying the first image and a second image positioned before the first image in the sequence, a position of the first image within the sequence, and display, based on executing a post-processing function with respect to the first image in accordance with the changed position, the first image changed by the post-processing function in the display.

In accordance with another aspect of the disclosure, a method performed by an electronic device is provided. The method includes identifying, in response to identifying an input indicating a selection of a first image through a display, a sequence for execution of a post-processing function, changing, based on identifying the first image and a second image positioned before the first image in the sequence, a position of the first image within the sequence, and displaying, based on executing a post-processing function with respect to the first image in accordance with the changed position, the first image changed by the post-processing function in the display.

In accordance with another aspect of the disclosure, one or more non-transitory computer readable storage media storing one or more programs including computer-executable instructions that, when executed by one or more processors individually or collectively, cause the electronic device to perform operations are provided. The operations include identifying, in response to identifying an input indicating a selection of a first image through a display, a sequence for execution of a post-processing function, changing, based on identifying the first image and a second image positioned before the first image in the sequence, a position of the first image within the sequence, and displaying, based on executing a post-processing function with respect to the first image in accordance with the changed position, the first image changed by the post-processing function in the display.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example of an electronic device that executes a post-processing function, according to an embodiment of the disclosure;

FIG. 2 illustrates an example of a block diagram of an electronic device according to an embodiment of the disclosure;

FIG. 3 illustrates an example of an electronic device that executes a post-processing function while executing a viewer application, according to an embodiment of the disclosure;

FIG. 4 illustrates an example of an electronic device that executes a post-processing function while executing an application different from a viewer application, according to an embodiment of the disclosure;

FIG. 5 illustrates an example of an electronic device that changes a sequence of a post-processing function with respect to an image based on a characteristic of the image, according to an embodiment of the disclosure;

FIG. 6 illustrates an example of a flowchart of an operation of an electronic device according to an embodiment of the disclosure;

FIG. 7 illustrates an example of a flowchart of an operation of an electronic device according to an embodiment of the disclosure;

FIG. 8 illustrates an example of a flowchart of an operation of an electronic device according to an embodiment of the disclosure;

FIG. 9 illustrates an example of a flowchart of an operation of an electronic device according to an embodiment of the disclosure; and

FIG. 10 is a block diagram of an electronic device in a network environment according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

Hereinafter, an electronic device may perform, based on obtaining a plurality of images, post-processing with respect to each of the plurality of images. The electronic device may determine a sequence for executing a post-processing function with respect to the plurality of images while performing the post-processing function with respect to each of the plurality of images. For example, the electronic device may determine the sequence in response to identification of an event.

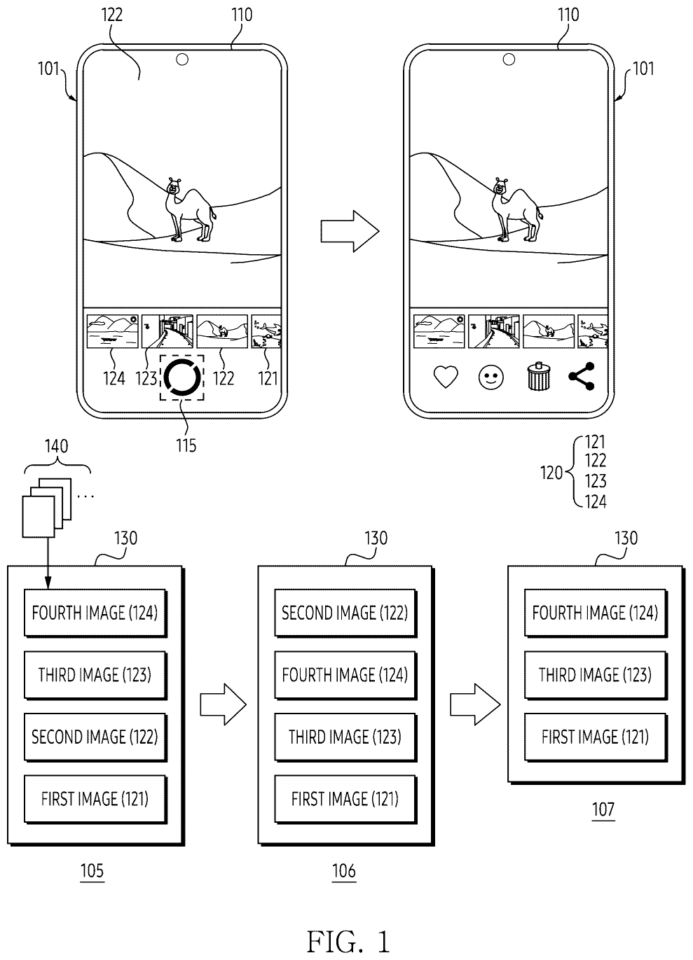

FIG. 1 illustrates an example of an electronic device that executes a post-processing function, according to an embodiment of the disclosure. An electronic device 101 of FIG. 1 may include a terminal owned by a user. For example, the terminal may include a personal computer (PC) such as a laptop or a desktop, a smartphone, a smartpad, a tablet PC, a smart accessory such as a smartwatch and a head-mounted device (HMD).

Referring to FIG. 1, according to an embodiment, the electronic device 101 may display images 120 using a viewer application. The viewer application may be executed on the electronic device 101 to view an image (e.g., the images 120). For example, the images 120 may be obtained based on a shooting application. For example, the electronic device 101 may obtain an image based on a shooting input while executing the shooting application. The shooting application may be executed in the electronic device 101 to obtain (or capture) an image (e.g., the images 120). For example, the image may be obtained based on a group of a plurality of sub-images obtained in response to the shooting input. For example, the image may be obtained based on a synthesis of the sub-images included in the group. The electronic device 101 may synthesize the plurality of sub-images based on obtaining the group of the plurality of sub-images in response to the shooting input. For example, the electronic device 101 may execute a post-processing function with respect to the group of the sub-images.

According to an embodiment, the post-processing function may include high dynamic range (HDR), portrait, low light shot (LLS), night mode adjustment, resolution adjustment, image filtering, and/or noise adjustment. For example, the HDR may be a function of increasing a difference in lightness between a portion displayed brightly and a portion displayed darkly in a screen based on the synthesis of the plurality of sub-images. For example, based on obtaining a plurality of sub-images including a person while shooting the person, the portrait may be a function of synthesizing the obtained plurality of sub-images. For example, the portrait may be a function of setting a focus on a subject. For example, the portrait may be a function of performing a blur effect with respect to a background surrounding the subject. For example, the portrait may be a function for performing a bokeh function such as an operation of rendering light out of the focus. For example, the portrait may be a function for obtaining an image that clearly represents the person by synthesizing the plurality of sub-images based on obtaining the plurality of sub-images including the person. For example, the portrait may obtain a depth map based on the plurality of sub-images and synthesize or divide the depth map. For example, the portrait may be a function of applying the blur effect with respect to the background based on the depth map. For example, based on obtaining the plurality of sub-images obtained in a low light environment, the LLS and/or the night mode adjustment may be a function of synthesizing the plurality of sub-images. For example, the LLS and/or the night mode adjustment may be a function of increasing lightness of an image by synthesizing the plurality of sub-images. The night mode adjustment may be referred to as a super-night function. For example, the resolution adjustment may be a function of obtaining a high-resolution image based on low-resolution sub-images. The resolution adjustment may be referred to as super-resolution. For example, the electronic device 101 may perform an operation related to artificial intelligence when obtaining the high-resolution image based the low-resolution sub-images. For example, the high resolution image may be obtained based on information obtained based on hardware (e.g., a central processing unit (CPU), a neural processing unit (NPU), and/or a graphics processing unit (GPU)) for performing operations related to artificial intelligence, software for providing a function related to the artificial intelligence, and/or an external electronic device (e.g., a server providing functions related to the artificial intelligence). For example, based on changing a pixel matrix forming the obtained image, the image filtering may be a function of changing the image. For example, the image filtering may include threshold processing and adaptive threshold processing. For example, the noise adjustment may be a function for removing noise in the image. The image filtering and/or the noise adjustment may be a function performed with respect to a single image. However, it is not limited thereto. Referring to FIG. 1, a group 140 of sub-images of a fourth image 124 is illustrated, but is not limited thereto.

According to an embodiment, the electronic device 101 may execute a post-processing function with respect to one of the images 120 in a first state 105. While executing the post-processing function, the electronic device 101 may display a visual object 115 for notifying that the post-processing function is being executed. For example, the visual object 115 may be a progress indicator. For example, the progress indicator may include a linear progress indicator and/or a circle progress indicator. The visual object 115 of FIG. 1 may be a circle progress indicator. The electronic device 101 may notify the user that the post-processing function is being executed with respect to one of the images 120 based on the display of the visual object 115 such as the progress indicator. However, it is not limited thereto.

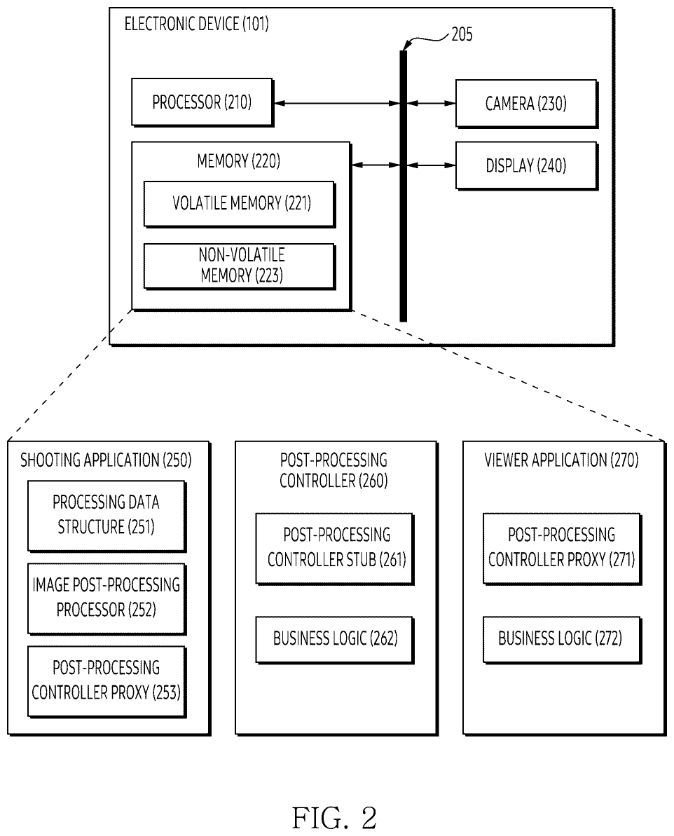

According to an embodiment, the electronic device 101 may identify a sequence for executing a post-processing function with respect to the images 120 in a stack area 130. For example, the stack area 130 may be formed in at least a portion of volatile memory (e.g., volatile memory 221 of FIG. 2) described below. In an embodiment, data sets stored in the stack area 130 formed in memory of the electronic device 101 may be accumulated (or stored) in or extracted from the stack area 130 based on last-in first-out (LIFO). For example, in the first state 105, the electronic device 101 may sequentially perform a post-processing function with respect to the fourth image 124, a third image 123, a second image 122, and a first image 121. The electronic device 101 may identify an event in the first state 105. For example, the event may be generated by the second image 122 being displayed through a screen 110. For example, the event may be generated by selecting and inputting at least one of a plurality of images 120. For example, the event may be generated by a change in a state of hardware components included in the electronic device 101.

For example, the electronic device 101 may change a sequence for executing the post-processing function with respect to the second image 122 based on the identification of the event. For example, the electronic device 101 may change a position (or the sequence for executing the post-processing function) of the second image 122 in the stack area 130. For example, the electronic device 101 may change the position of the second image 122 to a position before the fourth image 124. For example, the electronic device 101 may exchange the position of the second image 122 and the position of the fourth image 124. The electronic device 101 may execute the post-processing function with respect to the second image 122 before the fourth image 124 based on changing the position of the second image 122 in a second state 106. According to an embodiment, the electronic device 101 may identify completion of the post-processing with respect to the second image 122. The electronic device 101 may display the changed second image 122 in the screen 110 based on the completion of the post-processing with respect to the second image 122. While displaying the second image 122 in the screen 110, the electronic device 101 may execute the post-processing function with respect to the fourth image 124 positioned after the second image 122 in the stack area 130. For example, an example of executing the post-processing function with respect to the fourth image 124 may be referred to as a third state 107. According to an embodiment, in a case in which a post-processing function with respect to an image is being executed, the electronic device 101 may perform the post-processing function with respect to the image even when receiving a request for a post-processing function with respect to another image.

As described above, according to an embodiment, the electronic device 101 may identify the sequence for executing the post-processing function with respect to the plurality of images 120 in the stack area 130. The electronic device 101 may identify an event (e.g., an event for preferentially selecting and/or displaying at least one of the images 120) related to the images 120. The electronic device 101 may change the sequence for executing the post-processing function based on the identification of the event. For example, the electronic device 101 may change the position (or the sequence for executing the post-processing function) of the second image 122 in the stack area 130 in response to identification of the event related to the second image 122. For example, the electronic device 101 may change the position of the second image 122 to a position before the position of the fourth image 124. The electronic device 101 may exchange the position of the second image 122 and the position of the fourth image 124. The electronic device 101 may execute the post-processing function with respect to the second image 122 in response to exchanging the position of the fourth image 124 and the position of the second image 122. The electronic device 101 may provide the changed second image 122 to the user by preferentially executing the post-processing function with respect to the second image 122 based on the identification of the event with respect to the second image 122. The electronic device 101 may provide the changed second image 122 to the user by preferentially executing the post-processing function with respect to the second image 122, thereby enhancing user experience.

FIG. 2 illustrates an example of a block diagram of an electronic device according to an embodiment of the disclosure. An electronic device 101 of FIG. 2 may include the electronic device 101 of FIG. 1.

Referring to FIG. 2, according to an embodiment, the electronic device 101 may include at least one of a processor 210, memory 220, a camera 230, or a display 240. The processor 210, the memory 220, the camera 230, and the display 240 may be electronically and/or operably coupled with each other by an electronic component such as a communication bus 205. Hereinafter, hardware being operably coupled may mean that a direct connection or an indirect connection between the hardware is established by wire or wirelessly, such that second hardware is controlled by first hardware among the hardware. Although illustrated in different blocks, an embodiment is not limited thereto. A portion of hardware of FIG. 2 may be included in a single integrated circuit such as a system on a chip (SoC). A type and/or the number of hardware included in the electronic device 101 is not limited as illustrated in FIG. 2. For example, the electronic device 101 may include only a portion of the hardware illustrated in FIG. 2.

According to an embodiment, the electronic device 101 may include hardware for processing data based on one or more instructions. The hardware for processing data may include the processor 210. For example, the hardware for processing data may include an arithmetic and logic unit (ALU), a floating point unit (FPU), a field programmable gate array (FPGA), a central processing unit (CPU), and/or an application processor (AP). The processor 210 may have a structure of a single-core processor, or may have a structure of a multi-core processor such as a dual core, a quad core, a hexa core, or an octa core.

According to an embodiment, the memory 220 of the electronic device 101 may include a hardware component for storing data and/or instructions inputted to and/or outputted from the processor 210 of the electronic device 101. For example, the memory 220 may include volatile memory 221 such as random-access memory (RAM), and/or non-volatile memory 223 such as read-only memory (ROM). For example, the volatile memory 221 may include at least one of dynamic RAM (DRAM), static RAM (SRAM), cache RAM, and pseudo SRAM (PSRAM). For example, the non-volatile memory 223 may include at least one of programmable ROM (PROM), erasable PROM (EPROM), electrically erasable PROM (EEPROM), flash memory, a hard disk, a compact disk, a solid state drive (SSD), and an embedded multi-media card (eMMC). According to an embodiment, the electronic device 101 may execute an application stored in the non-volatile memory 223. The application may be referred to as a software application. The electronic device 101 may execute a post-processing function with respect to an image based on a shooting application 250, a post-processing controller 260, and/or a viewer application 270 included in the non-volatile memory 223.

According to an embodiment, the camera 230 of the electronic device 101 may include a lens assembly, a flash, or an image sensor. The lens assembly may collect light emitted from a subject, which is an object of an image shooting. The lens assembly may include one or more lenses. According to an embodiment, the camera 230 may include a plurality of lens assemblies. For example, in the camera 230, a portion of the plurality of lens assemblies may have the same lens property (e.g., angle of view, focal length, autofocus, f number, or optical zoom), or at least one lens assembly may have one or more lens properties that are different from lens properties of other lens assemblies. The lens assembly may include a wide-angle lens or a telephoto lens. For example, a flash of the camera 230 may emit light that is used to enhance light emitted or reflected from a subject. According to an embodiment, the flash may include one or more light-emitting diodes (e.g., a red-green-blue (RGB) light emitting diode (LED), a white LED, an infrared LED, or an ultraviolet LED), or a xenon lamp. For example, the image sensor may obtain an image corresponding to the subject by converting light emitted or reflected from the subject and transmitted through the lens assembly into an electrical signal. According to an embodiment, the image sensor may include one image sensor selected from among image sensors with different properties, such as, for example, an RGB sensor, a black and white (BW) sensor, an infrared (IR) sensor, or an ultraviolet (UV) sensor, a plurality of image sensors having the same property, or a plurality of image sensors having different properties. Each image sensor included in the image sensor may be, for example, implemented using a charged coupled device (CCD) sensor or a complementary metal oxide semiconductor (CMOS) sensor.

According to an embodiment, the display 240 of the electronic device 101 may output visualized information to a user. For example, the display 240 may output the visualized information to the user, by being controlled by the processor 210 including a circuit such as a graphics processing unit (GPU). The display 240 may include a flat panel display (FPD) and/or electronic paper. The FPD may include a liquid crystal display (LCD), a plasma display panel (PDP), and/or one or more light emitting diodes (LEDs). The LED may include an organic LED (OLED).

According to an embodiment, the display 240 of the electronic device 101 may include a sensor (e.g., a touch sensor panel (TSP)) for detecting an external object (e.g., a user's finger) on the display 240. For example, based on the TSP, the electronic device 101 may detect an external object that is in contact with the display 240 or floating on the display 240. For example, the electronic device 101 may identify a touch input that has detected an external object in contact with the display 240. For example, the electronic device 101 may identify a hovering input that has detected an external object floating on the display 240. In response to detecting the external object, the electronic device 101 may execute a function related to a specific visual object, among visual objects displayed in the display 240, corresponding to a position of the external object on the display 240.

According to an embodiment, the electronic device 101 may execute the shooting application 250 included in the non-volatile memory 223. According to an embodiment, the shooting application 250 may include a processing data structure 251, an image post-processing processor 252, and a post-processing controller proxy 253. The electronic device 101 may obtain a plurality of sub-images related to an image based on a shooting input while executing the shooting application 250. The electronic device 101 may obtain an image based on a group of the plurality of sub-images. For example, the electronic device 101 may synthesize the plurality of sub-images based on the image post-processing processor 252 included in the shooting application 250. The electronic device 101 may request an identifier with respect to an image for which execution of a post-processing function is required based on the post-processing controller proxy 253. The electronic device 101 may transmit data related to the image for which the execution of the post-processing function is required to the processing data structure 251 based on the post-processing controller proxy 253 received based on the request for the identifier. For example, the electronic device 101 may change a sequence of the group of the sub-images in the processing data structure 251 based on the identifier transmitted from the post-processing controller proxy 253. The processing data structure 251 is illustrated in the shooting application 250, but is not limited thereto. For example, the electronic device 101 may execute a post-processing function with respect to the image in an area formed in the volatile memory 221 using the processing data structure 251. The processing data structure 251 may be a stack structure.

According to an embodiment, the electronic device 101 may at least temporarily store the plurality of sub-images in the processing data structure 251. For example, the electronic device 101 may form a group of the plurality of sub-images stored in the processing data structure 251. The electronic device 101 may assign an identifier to the group of the plurality of sub-images. Hereinafter, the identifier assigned to the group of the sub-images may be a sequence identifier. The identifier may be related to an operation of obtaining an image using the group of the plurality of sub-images. For example, the electronic device 101 may execute a post-processing function with respect to the group of the plurality of sub-images based on the identifier. For example, the electronic device 101 may identify a sequence for executing a post-processing function with respect to groups including the group based on the identifier. For example, the electronic device 101 may position a group of the plurality of sub-images, in which execution duration of the post-processing function may be maintained beyond a preset time, in a position having a low priority. For example, the electronic device 101 may position the group of the plurality of sub-images below the processing data structure 251 having a stack structure. For example, the electronic device 101 may assign a first identifier corresponding to a first priority to a first group. The electronic device 101 may assign a second identifier corresponding to a second priority to a second group. For example, the second priority may be inferior to the first priority. The electronic device 101 may execute a post-processing function with respect to the first group and/or the second group based on the priority. According to an embodiment, the electronic device 101 may receive a request for execution of a post-processing function with respect to an image from the image post-processing processor 252 using the post-processing controller proxy 253. For example, the electronic device 101 may receive a request for execution of a post-processing function with respect to an image corresponding to the identifier based on the image post-processing processor 252.

According to an embodiment, the electronic device 101 may perform scheduling for executing a post-processing function with respect to the group of the plurality of sub-images based on the post-processing controller 260. The post-processing controller 260 according to an embodiment may include a post-processing controller stub 261 and business logic 262. The electronic device 101 may obtain an identifier corresponding to images corresponding to each of the groups of the plurality of sub-images based on the viewer application 270. The viewer application 270 according to an embodiment may include a post-processing controller proxy 271 and business logic 272. The business logic 262 and the business logic 272 may perform different operations. However, it is not limited thereto. According to an embodiment, the electronic device 101 may identify a sequence for performing post-processing with respect to the image among a plurality of applications based on the business logic 262. According to an embodiment, the electronic device 101 may receive an identifier corresponding to each of the images from the viewer application 270 using the post-processing controller stub 261. The identifier transmitted and/or received between applications may be a database identifier. The electronic device 101 may execute a post-processing function with respect to the images based on the identifier. For example, the electronic device 101 may execute a post-processing function with respect to the images based on changing the sequence of a group of sub-images corresponding to the identifier.

According to an embodiment, the electronic device 101 may display images obtained through the camera 230 using the viewer application 270. The viewer application 270 may be, for example, referred to as a gallery application. While executing a post-processing function with respect to the images, the electronic device 101 may display a visual object (e.g., the visual object 115 of FIG. 1) for notifying execution of the function. The electronic device 101 may display a visual object for notifying that post-processing for each of the images has been completed in response to completing the post-processing function with respect to each of the images. The electronic device 101 may transmit a sequence for executing a post-processing function with respect to the images displayed through the viewer application 270 to the image post-processing processor 252 using the post-processing controller proxy 271 included in the viewer application 270. The electronic device 101 may transmit database identifiers corresponding to the images displayed through the viewer application 270 to the post-processing controller 260. Hereinafter, the identifier transmitted and/or received between applications may be referred to as the database identifier. For example, the electronic device 101 may transmit data related to the sequence to the image post-processing processor 252.

According to an embodiment, the electronic device 101 may identify an event with respect to at least one of the images. For example, the electronic device 101 may change the sequence for executing the post-processing function with respect to the images based on the event. For example, the electronic device 101 may identify an input indicating a selection of a first image through the display 240. For example, the first image may be displayed using the viewer application 270. The electronic device 101 may identify an event for changing the sequence of the post-processing function in response to identifying the input. For example, the sequence for executing the post-processing function may be obtained based on the viewer application 270. In the sequence, the electronic device 101 may identify the first image and a second image positioned before the first image. For example, the electronic device 101 may identify the first image and the second image positioned before the first image based on the processing data structure 251. For example, the electronic device 101 may identify the first image and the second image disposed before the first image disposed in an area formed in the volatile memory 221. The electronic device 101 may change a position of the first image in the sequence based on identifying the first image and the second image. For example, the electronic device 101 may change the position of the first image to a position before a position of the second image in the sequence. The electronic device 101 may execute a post-processing function with respect to the first image in accordance with the changed position. For example, the electronic device 101 may execute the post-processing function with respect to the first image before executing a post-processing function with respect to the second image based on the changed positions in the sequence. For example, the electronic device 101 may exchange the position of the second image and the position of the first image. The electronic device 101 may preferentially execute the post-processing function with respect to the first image over the post-processing function with respect to the second image based on the exchanged position. The electronic device 101 may display the first image changed by the post-processing function based on executing the post-processing function with respect to the first image.

As described above, according to an embodiment, the electronic device 101 may identify an event for changing a sequence related to execution of a post-processing function with respect to images. The electronic device 101 may change the sequence of the execution of the post-processing function with respect to the images based on the identification of the event. The electronic device 101 may execute the post-processing function with respect to the images based on the changed sequence. The electronic device 101 may preferentially post-process images corresponding to the event and provide them to the user by executing the post-processing function based on the changed sequence. The electronic device 101 may enhance user experience by preferentially executing the post-processing function with respect to the images corresponding to the event.

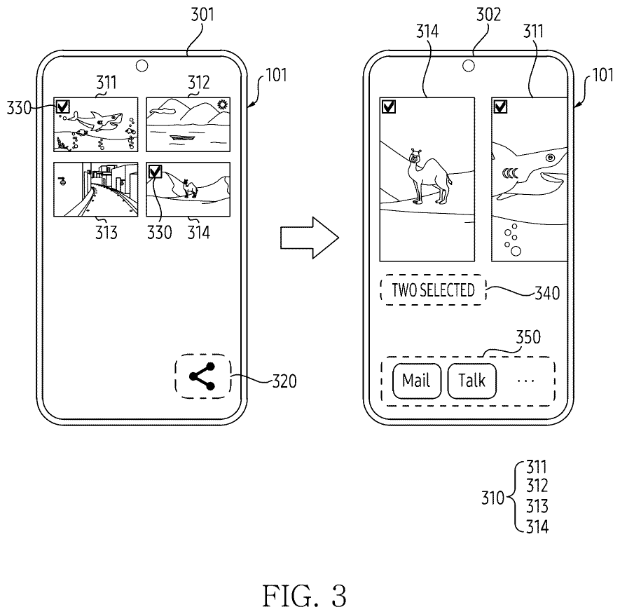

FIG. 3 illustrates an example of an electronic device that executes a post-processing function while executing a viewer application, according to an embodiment of the disclosure. An electronic device 101 of FIG. 3 may include the electronic device 101 of FIGS. 1 and/or 2. Operations of FIG. 3 may be performed by the processor 210 of FIG. 2.

Referring to FIG. 3, according to an embodiment, the electronic device 101 may display a screen 301 including images 310 through a display (e.g., the display 240 of FIG. 2). An example of FIG. 3 may be an example of the electronic device 101 displaying the screen 301 including a first image 311, a second image 312, a third image 313, and a fourth image 314. According to an embodiment, the electronic device 101 may identify a sequence for sequentially executing a post-processing function with respect to the fourth image 314, the third image 313, the second image 312, and the first image 311. The electronic device 101 may identify an event with respect to at least one of the images 310 while displaying the screen 301. For example, the event may be generated by an input that selects the at least one of the images 310.

For example, the electronic device 101 may identify the input that selects the at least one of the images 310. The electronic device 101 may display a visual object for notifying the selection based on the input that selects the at least one of the images 310. For example, the electronic device 101 may receive an input indicating a selection of the first image 311 and the fourth image 314. The electronic device 101 may display a visual object 330 for indicating the selection of the first image 311 and the fourth image 314 based on the input indicating the selection of the first image 311 and the fourth image 314. For example, the electronic device 101 may display the visual object 330 on at least a portion of the first image 311 and the fourth image 314. The electronic device 101 may change the sequence for executing the post-processing function from the fourth image 314 to the first image 311 based on the input indicating the selection of the first image 311 and the fourth image 314. For example, the electronic device 101 may maintain the sequence for executing the post-processing function with respect to the fourth image 314, based on an input indicating the selection of the fourth image 314. The electronic device 101 may identify a second input indicating the selection of the first image 311 after the first input indicating the selection of the fourth image 314. The electronic device 101 may change the sequence for executing the post-processing function with respect to the first image 311 in response to the second input. For example, the electronic device 101 may change the sequence for executing the post-processing function with respect to the first image 311 to a sequence prior to the sequence for executing the post-processing function with respect to the fourth image 314. The electronic device 101 may execute a post-processing function with respect to each of the images 310 based on the changed sequence. Before the changed sequence, the electronic device 101 may execute the post-processing function with respect to each of the images in the sequence of the fourth image 314, the third image 313, the second image 312, and the first image 311. For example, the electronic device 101 may execute the post-processing function with respect to the images 310 in a sequence of the first image 311, the fourth image 314, the second image 312, and the third image 313.

According to an embodiment, the electronic device 101 may identify an input indicating a selection of the visual object 320 for executing a function of sharing the first image 311 and the fourth image 314, after identifying the input indicating the selection of the first image 311 and the fourth image 314. The electronic device 101 may change the screen 301 based on the input indicating the selection of the visual object 320. For example, the electronic device 101 may display a screen 302 based on the execution of the function of sharing the first image 311 and the fourth image 314. For example, the electronic device 101 may display a visual object 340 for notifying the number of selected images in the screen 302. The electronic device 101 may display visual objects 350 representing a means for sharing the selected images in the screen 302. The electronic device 101 may identify the first image 311 displayed in the screen 302. The electronic device 101 may preferentially execute a post-processing function with respect to the first image 311 displayed in the screen 302. In an example of FIG. 3, an example is illustrated in which the post-processing function with respect to the fourth image 314 is preferentially executed, but in a case in which the first image 311 is displayed in the screen 302, the post-processing function with respect to the fourth image 314 may be preferentially executed over the post-processing function with respect to the first image 311.

For example, the electronic device 101 may execute the post-processing function with respect to the images in the sequence of the fourth image 314, the third image 313, the second image 312, and the first image 311 before identifying the input with respect to the first image 311 and the fourth image 314 in the first screen 301. The electronic device 101 may identify the input with respect to the first image 311 and the fourth image 314 among the images. The electronic device 101 may activate the visual object 330 based on identifying the input with respect to the first image 311 and the fourth image 314. For example, the visual object 330 may be referred to as a check box. The electronic device 101 may change to the second screen 302 for sharing the first image 311 and the fourth image 314 based on an input with respect to the visual object 320, while selecting the first image 311 and the fourth image 314. The electronic device 101 may change the sequence for executing the post-processing function with respect to the first image 311 and the fourth image 314, based on changing to the second screen 302. For example, the electronic device 101 may preferentially execute the post-processing function with respect to the fourth image 314 displayed on the second screen 302 over the post-processing function with respect to other images (e.g., the first image 311, the second image 312, and/or the third image 313). The electronic device 101 may execute the post-processing function with respect to the first image 311 in response to completing the post-processing function with respect to the fourth image 314. For example, the electronic device 101 may preferentially execute the post-processing function with respect to the first image 311 over the post-processing function with respect to the second image 312 and the third image 313.

As described above, according to an embodiment, the electronic device 101 may preferentially execute a post-processing function with respect to an image displayed through a display. The electronic device 101 may enhance user experience by preferentially executing and displaying the post-processing function with respect to the image.

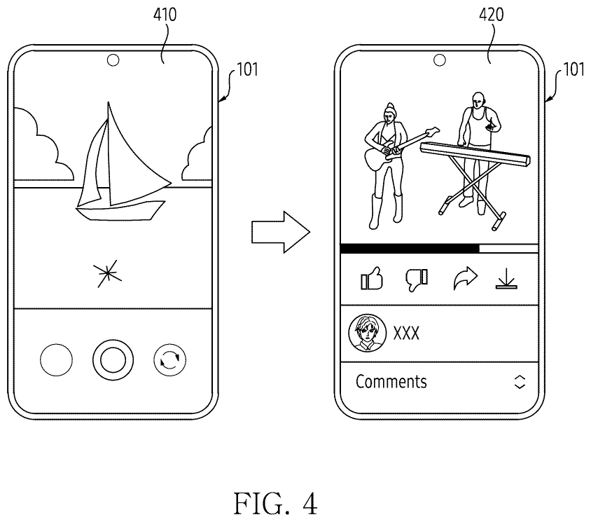

FIG. 4 illustrates an example of an electronic device that executes a post-processing function while executing an application different from a viewer application, according to an embodiment of the disclosure. An electronic device 101 of FIG. 4 may be an example of the electronic device 101 of FIGS. 1, 2, and/or 3. An operation of FIG. 4 may be performed by the processor 210 of FIG. 2.

Referring to FIG. 4, according to an embodiment, the electronic device 101 may identify a state of hardware components included in the electronic device 101. For example, the state of the hardware components may include a state of a processor 210, a temperature of the electronic device 101, usage of memory (e.g., the volatile memory 221 of FIG. 2), a state of a neural processing unit (NPU), and a state of a graphics processing unit (GPU). The electronic device 101 may change a sequence for executing a post-processing function with respect to images based on the state of the hardware component. For example, the electronic device 101 may identify that a temperature of the electronic device 101 is greater than or equal to a reference temperature (e.g., approximately 45° C.). The electronic device 101 may change the sequence for executing the post-processing function with respect to the images based on the temperature of the electronic device 101 that is greater than or equal to the reference temperature. According to an embodiment, the electronic device 101 may at least temporarily suspend the post-processing function with respect to the images based on the temperature of the electronic device 101 that is greater than or equal to the reference temperature. For example, the electronic device 101 may identify usage of memory. For example, the electronic device 101 may identify that the usage of the memory is greater than or equal to a reference usage (e.g., approximately 33%). The electronic device 101 may change the sequence for executing the post-processing function with respect to the images based on identifying the usage of the memory that is greater than or equal to the reference usage. According to an embodiment, the electronic device 101 may at least temporarily suspend the post-processing function with respect to the images based on identifying the usage of the memory that is greater than or equal to the reference usage. For example, the electronic device 101 may identify a state of the processor 210, the NPU, and/or the GPU. The state of the processor 210, the NPU, and/or the GPU may be usage of the processor 210, usage of the NPU, and/or usage of the GPU. The electronic device 101 may change the sequence for executing the post-processing function with respect to the images based on the state of the processor 210, the NPU, and/or the GPU. According to an embodiment, the electronic device 101 may at least temporarily suspend the post-processing function with respect to the images in response to the state of the processor 210, the NPU, and/or the GPU.

Referring to FIG. 4, according to an embodiment, the electronic device 101 may display a first image 410 based on a viewer application (e.g., the viewer application 270 of FIG. 2) for displaying an image. In response to displaying the first image 410, the electronic device 101 may change a sequence for executing a post-processing function with respect to the first image 410. For example, the electronic device 101 may change the sequence for executing the post-processing function with respect to the first image 410 to a sequence prior to a sequence for executing a post-processing function with respect to other images. According to an embodiment, the electronic device 101 may identify execution of a first application (e.g., a video playback application or a social media application) that is different from the viewer application based on changing the sequence with respect to the first image 410. The electronic device 101 may at least temporarily suspend the execution of the post-processing function with respect to the first image 410 in response to the execution of the first application. For example, the electronic device 101 may identify usage of memory that is greater than or equal to a reference usage based on the execution of the first application. The electronic device 101 may at least temporarily suspend the execution of the post-processing function with respect to the first image 410 in response to identifying the usage of the memory that is greater than or equal to the reference usage.

As described above, according to an embodiment, the electronic device 101 may change the sequence for executing the post-processing function with respect to the images based on the state of the hardware components included in the electronic device 101. The electronic device 101 may at least temporarily suspend the execution of the post-processing function with respect to the images based on the state of the hardware components. The electronic device 101 may reduce the usage of the memory (or the processor) by at least temporarily suspending the execution of the post-processing function based on the state of the hardware components.

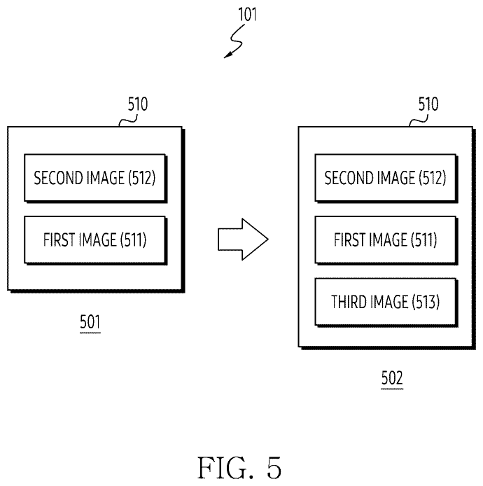

FIG. 5 illustrates an example of an electronic device that changes a sequence of a post-processing function with respect to an image based on a characteristic of the image, according to an embodiment of the disclosure. An electronic device 101 of FIG. 5 may include the electronic device 101 of FIGS. 1, 2, 3, and/or 4. Operations of FIG. 5 may be performed by the processor 210 of FIG. 2.

Referring to FIG. 5, according to an embodiment, the electronic device 101 may form a stack area 510 in volatile memory (e.g., the volatile memory 221 of FIG. 2). The electronic device 101 may perform, based on positions of images in the stack area 510, a post-processing function with respect to the images. The electronic device 101 may change the positions of the images in the stack area 510 based on a characteristic of each of the images. For example, the characteristic of the image may be related to a pixel of the image. For example, the characteristic of the image may be related to a size of a file corresponding to the image. For example, the electronic device 101 may set a sequence for executing a post-processing function with respect to an image having a pixel greater than or equal to a preset pixel (e.g., approximately 100 mega pixel (MP)) to a lower priority. The electronic device 101 may position the image having a pixel greater than or equal to the preset pixel in a position corresponding to a lower priority. An example of FIG. 5 may be an example in which a third image 513 is positioned inferior to a first image 511 and a second image 512.

According to an embodiment, the electronic device 101 may identify the second image 512 of a first priority and the first image 511 of a second priority in the stack area 510. The electronic device 101 may sequentially execute a post-processing function with respect to the first image 511 and the second image 512 based on the priorities. For example, the electronic device 101 may execute the post-processing function with respect to the first image 511 after completing the post-processing function with respect to the second image 512 based on the second priority which is inferior to the first priority. The electronic device 101 may execute a post-processing function based on the priority corresponding to the first image 511 and the second image 512. For example, the electronic device 101 may execute the post-processing function with respect to the second image 512 of the first priority before the first image 511 of the second priority. The electronic device 101 may obtain the third image 513 in a state 501 in which the first image 511 and the second image 512 are identified in the stack area 510. In the example of FIG. 5, the third image 513 may be an image having a pixel greater than or equal to the preset pixel (e.g., approximately 100 mega pixel (MP)). The electronic device 101 may preset a sequence for executing a post-processing function with respect to the third image 513 based on obtaining the third image 513. For example, the electronic device 101 may execute the post-processing function with respect to the third image 513 with a relatively lower priority than the post-processing function with respect to the first image 511 and the second image 512, based on the pixel of the third image 513 exceeding the preset pixel. For example, in response to obtaining the third image 513, the electronic device 101 may position a position of the third image 513 to a position after a position of the second image 512 and a position of the first image 511. The electronic device 101 may execute the post-processing function with respect to each of the images based on the positions corresponding to each of the images. According to an embodiment, the electronic device 101 may execute the post-processing function with respect to the third image 513 having a pixel greater than or equal to the preset pixel in response to termination of a shooting application (e.g., the shooting application 250 of FIG. 2). For example, the electronic device 101 may reduce usage of a hardware component by executing the post-processing function with respect to the third image 513 having a pixel greater than or equal to the preset pixel by positioning it with a lower priority.

As described above, according to an embodiment, the electronic device 101 may change (or set) the sequence for executing the post-processing function with respect to the images based on the characteristic of the image. For example, the electronic device 101 may execute the post-processing function based on the sequence. The electronic device 101 may reduce usage of memory (or a processor) by executing the post-processing function with respect to the images based on the characteristic of the image. The electronic device 101 may enhance user experience of the electronic device 101 by executing the post-processing function with respect to the images based on the characteristic of the image.

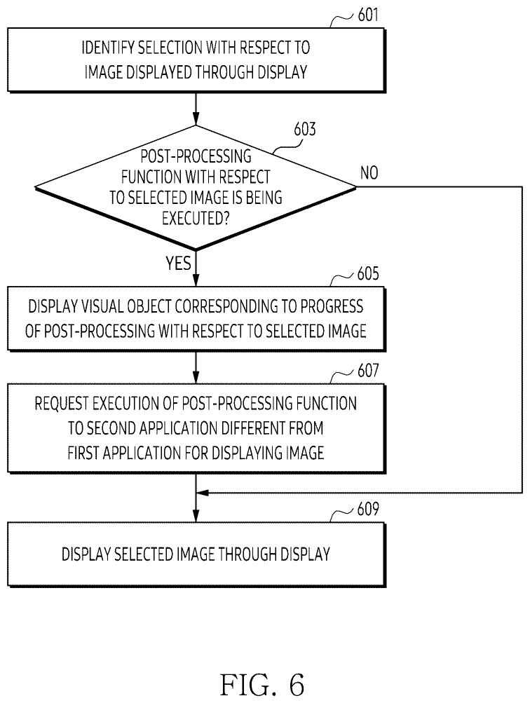

FIG. 6 illustrates an example of a flowchart of an operation of an electronic device according to an embodiment of the disclosure. The electronic device of FIG. 6 may include the electronic device 101 of FIGS. 1, 2, 3, 4, and/or 5. Operations of FIG. 6 may be performed by the processor 210 of FIG. 2.

Referring to FIG. 6, in operation 601, according to an embodiment, the electronic device may identify a selection with respect to an image displayed through a display (e.g., the display 240 of FIG. 2). For example, the electronic device 101 may identify the selection with respect to the image while displaying the image through the display, based on a first application. For example, the first application may be referred to as the viewer application 270 of FIG. 2. For example, the electronic device may display the image through the display, based on execution of a viewer application (e.g., the viewer application 270 of FIG. 2). The electronic device may identify the selection with respect to the image displayed using the viewer application.

In operation 603, according to an embodiment, the electronic device may identify whether to execute a post-processing function with respect to the selected image. For example, the electronic device may identify whether a post-processing function with respect to the image displayed through the viewer application is being executed.

In a case in which the post-processing function with respect to the selected image is being executed (603—YES), in operation 605, according to an embodiment, the electronic device may display a visual object corresponding to a progress of the post-processing with respect to the selected image. According to an embodiment, the electronic device may at least temporarily suspend displaying the visual object for notifying the execution of the post-processing function. For example, the visual object may be referred to as the visual object 115 of FIG. 1. For example, the visual object may include a progress indicator. For example, the visual object may include a linear progress indicator. For example, the visual object may include a circle progress indicator.

In operation 607, according to an embodiment, the electronic device may request the execution of the post-processing function from a second application (e.g., the post-processing controller 260 of FIG. 2) different from the first application (e.g., the viewer application) for displaying the image. For example, the electronic device 101 may request the second application the execution of the post-processing function with respect to the selected image. For example, when requesting the execution of the post-processing function, the electronic device 101 may transmit an identifier corresponding to the image to the second application. For example, the identifier may be referred to as a database identifier.

In a case in which the post-processing function with respect to the selected image is not being executed (603-NO), in operation 609, according to an embodiment, the electronic device may display the selected image through the display. For example, the electronic device may display a changed image based on completion of the post-processing with respect to the image, through the display. For example, the electronic device may display the selected image in the operation 601 through the display.

As described above, according to an embodiment, the electronic device may identify whether the post-processing with respect to the selected image is completed. The electronic device may display the visual object for notifying that the post-processing function with respect to the selected image is being executed. The electronic device may suspend displaying the visual object based on the completion of the post-processing function with respect to the selected image. The electronic device may change the selected image based on the post-processing function with respect to the selected image. The electronic device may preferentially execute the post-processing function with respect to the image displayed through the display by executing the post-processing function in response to the selection. The electronic device may enhance the user experience of the electronic device by preferentially executing the post-processing function with respect to the selected and/or the displayed image.

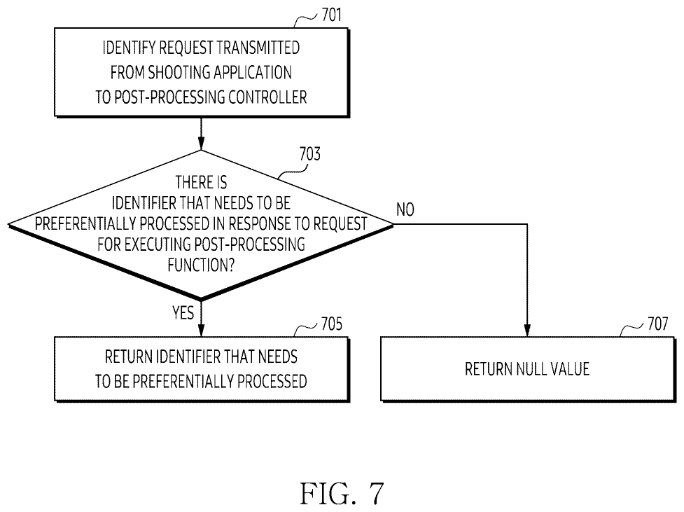

FIG. 7 illustrates an example of a flowchart of an operation of an electronic device according to an embodiment of the disclosure. The electronic device of FIG. 7 may include the electronic device 101 of FIGS. 1, 2, 3, 4 and/or 5 and/or the electronic device of FIG. 6. Operations of FIG. 7 may be executed by the processor 210 of FIG. 2.

Referring to FIG. 7, in operation 701, the electronic device according to an embodiment may obtain an image based on a shooting application (e.g., the shooting application 250 of FIG. 2). The electronic device may identify a request transmitted from the shooting application to a post-processing controller (e.g., the post-processing controller 260 of FIG. 2). For example, the electronic device may identify a request for executing a post-processing function with respect to a first image.

In operation 703, according to an embodiment, the electronic device may identify whether there is an identifier that needs to be preferentially processed in response to a request for executing the post-processing function. For example, the identifier may be referred to as a database identifier. For example, the identifier that needs to be preferentially processed may be an identifier for executing a post-processing function with respect to an image to which the identifier that needs to be preferentially processed is assigned before a post-processing function with respect to images different from the image. The electronic device may return the identifier based on a query request received from the shooting application. The identifier may be referenced as the database identifier. For example, the electronic device may identify whether there is a second image based on the identifier obtained in FIG. 6. For example, the second image may be an image for which the post-processing function should be preferentially executed over the first image. For example, the second image may be an image positioned before the first image. For example, the first image may be a selected image.

In a case in which there is an identifier that needs to be preferentially processed (703—YES), in operation 705, according to an embodiment, the electronic device may return an identifier corresponding to the first image. For example, the identifier corresponding to the first image may be an identifier corresponding to the last-obtained image. For example, the last-obtained image may be positioned at the top of a stack area.

In a case in which there is no identifier that needs to be preferentially processed (703—NO), in operation 707, according to an embodiment, the electronic device may return a null value. For example, the null value may be a value for indicating that a value does not exist. When returning the null value, the electronic device may maintain the sequence for executing the post-processing function with respect to the images.

As described above, according to an embodiment, the electronic device may identify whether there is an identifier that needs to be preferentially processed in response to a request for executing a post-processing function. The electronic device may preferentially execute a post-processing function with respect to an image corresponding to the identifier based on identifying the identifier that needs to be preferentially processed. The electronic device may return a null value based on failing to identify the identifier that needs to be preferentially processed. The electronic device may maintain a sequence for executing the post-processing function with respect to the images based on returning the null value. The electronic device may enhance user experience by executing a post-processing function based on the identifier that needs to be preferentially processed.

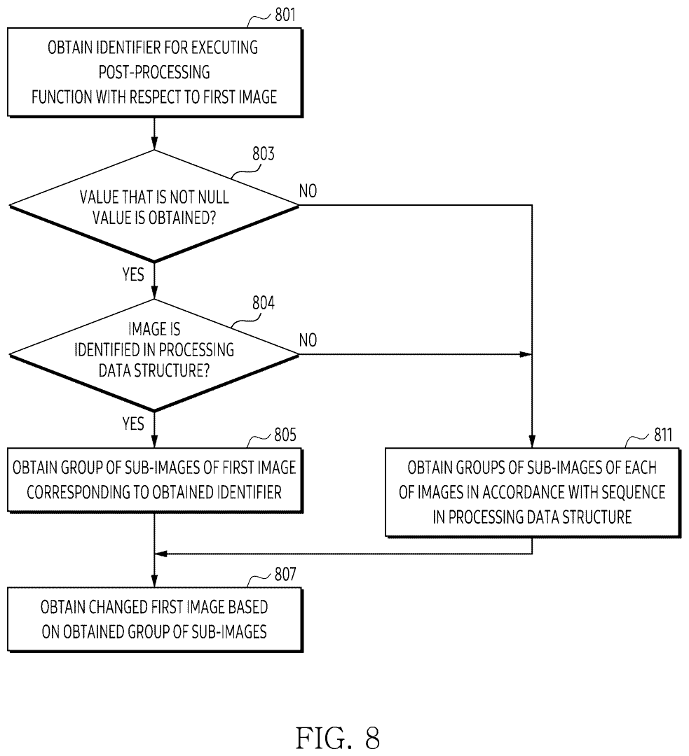

FIG. 8 illustrates an example of a flowchart of an operation of an electronic device according to an embodiment of the disclosure. The electronic device of FIG. 8 may include the electronic device 101 of FIG. 1, 2, 3, 4, and/or the electronic device of FIGS. 5, 6, and/or 7. Operations of FIG. 8 may be performed by the processor 210 of FIG. 2.

Referring to FIG. 8, in operation 801, according to an embodiment, the electronic device may obtain an identifier for executing a post-processing function with respect to a first image from a post-processing controller (e.g., the post-processing controller 260 of FIG. 2) based on a shooting application (e.g., the shooting application 250 of FIG. 2). For example, the electronic device may identify a selection with respect to the first image displayed through a display. The electronic device may obtain an identifier related to a sequence for executing the post-processing function with respect to the first image based on identifying the selection. The electronic device may execute the post-processing function with respect to the first image in accordance with a sequence corresponding to the identifier based on obtaining the identifier. The identifier may be related to the sequence for executing the post-processing function with respect to an image.

In operation 803, according to an embodiment, the electronic device may identify whether the obtained identifier is valid. For example, the electronic device may identify whether the obtained identifier is a null value. For example, the null value may be an invalid value. For example, the electronic device may identify validity of the identifier based on reception of the identifier for execution of the post-processing function with respect to the first image. For example, the electronic device may identify that the identifier for executing the post-processing function with respect to the first image is valid. The electronic device may identify that the identifier for executing the post-processing function with respect to the first image is invalid.

In a case in which a non-null value is obtained (803—YES), in operation 804, according to an embodiment, the electronic device may identify whether an image is identified in a processing data structure (e.g., the processing data structure 251 of FIG. 2). For example, the electronic device may identify whether there is an identifier corresponding to the image in the processing data structure. According to an embodiment, the electronic device may identify the image in the processing data structure. In a case in which the image is identified in the processing data structure (804—YES), in operation 805, according to an embodiment, the electronic device may obtain a group of sub-images of the first image corresponding to the obtained identifier. For example, the sub-images of the first image may be obtained through a camera (e.g., the camera 230 of FIG. 2). The electronic device may display one of the sub-images. For example, the one of the displayed sub-images may be referred to as a temporary image.

In a case in which an image is not identified in the processing data structure (804—NO), or the null value is obtained (803—NO), in operation 811, according to an embodiment, the electronic device may obtain groups of sub-images of each of the images in accordance with a sequence in the processing data structure. For example, a case in which the electronic device obtains the null value may be a case in which the identifier obtained by the electronic device is valid. The electronic device may synthesize the group of the sub-images of each of the images in accordance with the sequence in the processing data structure. The electronic device may execute a post-processing function with respect to the images in accordance with the sequence, based on obtaining the groups of the sub-images of each of the images.

In operation 807, according to an embodiment, the electronic device may obtain the changed first image based on the obtained group of the sub-images. For example, the electronic device may synthesize sub-images related to the first image. For example, the electronic device may obtain the first image based on the synthesis of the sub-images. The synthesis of the sub-images may be performed based on the execution of the post-processing function. The electronic device may obtain the changed first image by executing a post-processing function with respect to the group of the sub-images.

As described above, according to an embodiment, the electronic device may synthesize the group of the sub-images in accordance with the sequence in the processing data structure. The electronic device may change the sequence based on the identifier. The electronic device may synthesize the group of the sub-images based on the changed sequence. The electronic device may enhance user experience of the electronic device by synthesizing the group of the sub-images based on the identifier.

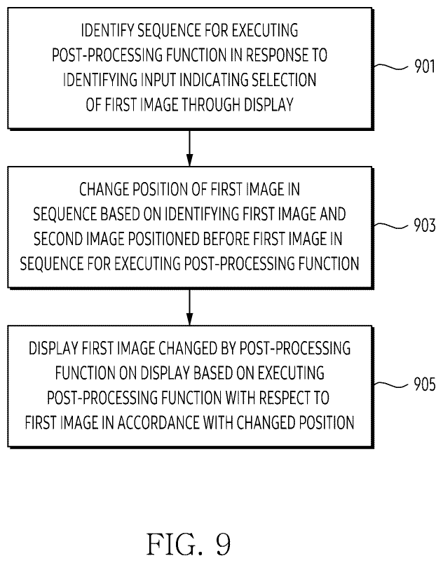

FIG. 9 illustrates an example of a flowchart of an operation of an electronic device according to an embodiment of the disclosure. The electronic device of FIG. 9 may include the electronic device 101 of FIGS. 1, 2, 3, 4, and/or 5 and the electronic device of FIGS. 6, 7, and/or 8. Operations of FIG. 9 may be performed by the processor 210 of FIG. 2.

Referring to FIG. 9, in operation 901, the electronic device according to an embodiment may identify an input indicating a selection of a first image through a display (e.g., the display 240 of FIG. 2). The electronic device may identify a sequence for executing a post-processing function in response to identifying the input indicating the selection of the first image through the display.

In operation 903, according to an embodiment, the electronic device may change a position of the first image in the sequence for executing the post-processing function based on identifying the first image and a second image positioned before the first image in the sequence for executing the post-processing function. For example, the electronic device may change the position of the first image in the sequence for executing the post-processing function to a position before a position of the second image in the sequence for executing the post-processing function, based on identifying the first image and the second image positioned before the first image in the sequence for executing the post-processing function. For example, the electronic device may exchange the position of the first image and the position of the second image. The electronic device may execute a post-processing function with respect to the first image based on the position of the first image and the position of the second image that are exchanged.

In operation 905, according to an embodiment, the electronic device may display the first image changed by the post-processing function on the display based on executing the post-processing function with respect to the first image in accordance with the changed position. For example, the electronic device may execute the post-processing function with respect to the first image before executing the post-processing function with respect to the second image based on the changed positions in the sequence. The electronic device may execute the post-processing function with respect to the first image with a first priority. The electronic device may execute the post-processing function with respect to the second image with a second priority that is inferior to the first priority, based on completing the post-processing function with respect to the first image.

As described above, according to an embodiment, the electronic device may change the sequence for executing the post-processing function with respect to the images (e.g., the first image and the second image). For example, the electronic device may change the sequence for executing the post-processing function with respect to the first image based on an input with respect to the first image. The electronic device may preferentially execute the post-processing function with respect to the first image over execution of the post-processing function with respect to the second image. The electronic device may enhance user experience of the electronic device by preferentially executing the post-processing function with respect to the selected first image over the post-processing function on the second image.

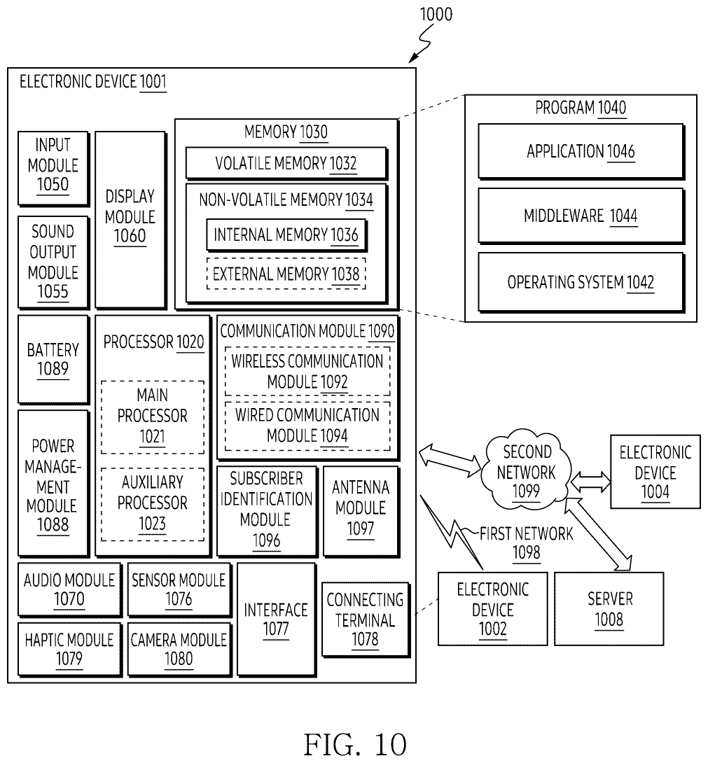

FIG. 10 is a block diagram of an electronic device in a network environment according to an embodiment of the disclosure.

Referring to FIG. 10, the electronic device 1001 in the network environment 1000 may communicate with an external electronic device 1002 via a first network 1098 (e.g., a short-range wireless communication network), or at least one of an external electronic device 1004 or a server 1008 via a second network 1099 (e.g., a long-range wireless communication network). According to an embodiment, the electronic device 1001 may communicate with the external electronic device 1004 via the server 1008. According to an embodiment, the electronic device 1001 may include a processor 1020, memory 1030, an input module 1050, a sound output module 1055, a display module 1060, an audio module 1070, a sensor module 1076, an interface 1077, a connecting terminal 1078, a haptic module 1079, a camera module 1080, a power management module 1088, a battery 1089, a communication module 1090, a subscriber identification module (SIM) 1096, or an antenna module 1097. In some embodiments, at least one of the components (e.g., the connecting terminal 1078) may be omitted from the electronic device 1001, or one or more other components may be added in the electronic device 1001. In some embodiments, some of the components (e.g., the sensor module 1076, the camera module 1080, or the antenna module 1097) may be implemented as a single component (e.g., the display module 1060).

The processor 1020 may execute, for example, software (e.g., a program 1040) to control at least one other component (e.g., a hardware or software component) of the electronic device 1001 coupled with the processor 1020, and may perform various data processing or computation. According to an embodiment, as at least part of the data processing or computation, the processor 1020 may store a command or data received from another component (e.g., the sensor module 1076 or the communication module 1090) in volatile memory 1032, process the command or the data stored in the volatile memory 1032, and store resulting data in non-volatile memory 1034. According to an embodiment, the processor 1020 may include a main processor 1021 (e.g., a central processing unit (CPU) or an application processor (AP)), or an auxiliary processor 1023 (e.g., a graphics processing unit (GPU), a neural processing unit (NPU), an image signal processor (ISP), a sensor hub processor, or a communication processor (CP)) that is operable independently from, or in conjunction with, the main processor 1021. For example, when the electronic device 1001 includes the main processor 1021 and the auxiliary processor 1023, the auxiliary processor 1023 may be adapted to consume less power than the main processor 1021, or to be specific to a specified function. The auxiliary processor 1023 may be implemented as separate from, or as part of the main processor 1021.

The auxiliary processor 1023 may control at least some of functions or states related to at least one component (e.g., the display module 1060, the sensor module 1076, or the communication module 1090) among the components of the electronic device 1001, instead of the main processor 1021 while the main processor 1021 is in an inactive (e.g., sleep) state, or together with the main processor 1021 while the main processor 1021 is in an active state (e.g., executing an application). According to an embodiment, the auxiliary processor 1023 (e.g., an image signal processor or a communication processor) may be implemented as part of another component (e.g., the camera module 1080 or the communication module 1090) functionally related to the auxiliary processor 1023. According to an embodiment, the auxiliary processor 1023 (e.g., the neural processing unit) may include a hardware structure specified for artificial intelligence model processing. An artificial intelligence model may be generated by machine learning. Such learning may be performed, e.g., by the electronic device 1001 where the artificial intelligence is performed or via a separate server (e.g., the server 1008). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1030 may store various data used by at least one component (e.g., the processor 1020 or the sensor module 1076) of the electronic device 1001. The various data may include, for example, software (e.g., the program 1040) and input data or output data for a command related thereto. The memory 1030 may include the volatile memory 1032 or the non-volatile memory 1034.

The program 1040 may be stored in the memory 1030 as software, and may include, for example, an operating system (OS) 1042, middleware 1044, or an application 1046.

The input module 1050 may receive a command or data to be used by another component (e.g., the processor 1020) of the electronic device 1001, from the outside (e.g., a user) of the electronic device 1001. The input module 1050 may include, for example, a microphone, a mouse, a keyboard, a key (e.g., a button), or a digital pen (e.g., a stylus pen).

The sound output module 1055 may output sound signals to the outside of the electronic device 1001. The sound output module 1055 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1060 may visually provide information to the outside (e.g., a user) of the electronic device 1001. The display module 1060 may include, for example, a display, a hologram device, or a projector and control circuitry to control a corresponding one of the display, hologram device, and projector. According to an embodiment, the display module 1060 may include a touch sensor adapted to detect a touch, or a pressure sensor adapted to measure the intensity of force incurred by the touch.

The audio module 1070 may convert a sound into an electrical signal and vice versa. According to an embodiment, the audio module 1070 may obtain the sound via the input module 1050, or output the sound via the sound output module 1055 or a headphone of an external electronic device (e.g., an external electronic device 1002) directly (e.g., wiredly) or wirelessly coupled with the electronic device 1001.

The sensor module 1076 may detect an operational state (e.g., power or temperature) of the electronic device 1001 or an environmental state (e.g., a state of a user) external to the electronic device 1001, and then generate an electrical signal or data value corresponding to the detected state. According to an embodiment, the sensor module 1076 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1077 may support one or more specified protocols to be used for the electronic device 1001 to be coupled with the external electronic device (e.g., the external electronic device 1002) directly (e.g., wiredly) or wirelessly. According to an embodiment, the interface 1077 may include, for example, a high definition multimedia interface (HDMI), a universal serial bus (USB) interface, a secure digital (SD) card interface, or an audio interface.

A connecting terminal 1078 may include a connector via which the electronic device 1001 may be physically connected with the external electronic device (e.g., the external electronic device 1002). According to an embodiment, the connecting terminal 1078 may include, for example, an HDMI connector, a USB connector, a SD card connector, or an audio connector (e.g., a headphone connector).

The haptic module 1079 may convert an electrical signal into a mechanical stimulus (e.g., a vibration or a movement) or electrical stimulus which may be recognized by a user via his tactile sensation or kinesthetic sensation. According to an embodiment, the haptic module 1079 may include, for example, a motor, a piezoelectric element, or an electric stimulator.

The camera module 1080 may capture a still image or moving images. According to an embodiment, the camera module 1080 may include one or more lenses, image sensors, image signal processors, or flashes.

The power management module 1088 may manage power supplied to the electronic device 1001. According to an embodiment, the power management module 1088 may be implemented as at least part of, for example, a power management integrated circuit (PMIC).

The battery 1089 may supply power to at least one component of the electronic device 1001. According to an embodiment, the battery 1089 may include, for example, a primary cell which is not rechargeable, a secondary cell which is rechargeable, or a fuel cell.

The communication module 1090 may support establishing a direct (e.g., wired) communication channel or a wireless communication channel between the electronic device 1001 and the external electronic device (e.g., the external electronic device 1002, the external electronic device 1004, or the server 1008) and performing communication via the established communication channel. The communication module 1090 may include one or more communication processors that are operable independently from the processor 1020 (e.g., the application processor (AP)) and supports a direct (e.g., wired) communication or a wireless communication. According to an embodiment, the communication module 1090 may include a wireless communication module 1092 (e.g., a cellular communication module, a short-range wireless communication module, or a global navigation satellite system (GNSS) communication module) or a wired communication module 1094 (e.g., a local area network (LAN) communication module or a power line communication (PLC) module). A corresponding one of these communication modules may communicate with the external electronic device via the first network 1098 (e.g., a short-range communication network, such as Bluetooth™, wireless-fidelity (Wi-Fi) direct, or infrared data association (IrDA)) or the second network 1099 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1092 may identify and authenticate the electronic device 1001 in a communication network, such as the first network 1098 or the second network 1099, using subscriber information (e.g., international mobile subscriber identity (IMSI)) stored in the subscriber identification module 1096.

The wireless communication module 1092 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1092 may support a high-frequency band (e.g., the mmWave band) to achieve, e.g., a high data transmission rate. The wireless communication module 1092 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1092 may support various requirements specified in the electronic device 1001, an external electronic device (e.g., the external electronic device 1004), or a network system (e.g., the second network 1099). According to an embodiment, the wireless communication module 1092 may support a peak data rate (e.g., 20 Gbps or more) for implementing eMBB, loss coverage (e.g., 1064 dB or less) for implementing mMTC, or U-plane latency (e.g., 0.5 ms or less for each of downlink (DL) and uplink (UL), or a round trip of 10 ms or less) for implementing URLLC.

The antenna module 1097 may transmit or receive a signal or power to or from the outside (e.g., the external electronic device) of the electronic device 1001. According to an embodiment, the antenna module 1097 may include an antenna including a radiating element composed of a conductive material or a conductive pattern formed in or on a substrate (e.g., a printed circuit board (PCB)). According to an embodiment, the antenna module 1097 may include a plurality of antennas (e.g., array antennas). In such a case, at least one antenna appropriate for a communication scheme used in the communication network, such as the first network 1098 or the second network 1099, may be selected, for example, by the communication module 1090 (e.g., the wireless communication module 1092) from the plurality of antennas. The signal or the power may then be transmitted or received between the communication module 1090 and the external electronic device via the selected at least one antenna. According to an embodiment, another component (e.g., a radio frequency integrated circuit (RFIC)) other than the radiating element may be additionally formed as part of the antenna module 1097.

According to various embodiments, the antenna module 1097 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1001 and the external electronic device 1004 via the server 1008 coupled with the second network 1099. Each of the external electronic devices 1002 or 1004 may be a device of a same type as, or a different type, from the electronic device 1001. According to an embodiment, all or some of operations to be executed at the electronic device 1001 may be executed at one or more of the external electronic devices 1002 or 1004, or the server 1008. For example, if the electronic device 1001 should perform a function or a service automatically, or in response to a request from a user or another device, the electronic device 1001, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1001. The electronic device 1001 may provide the outcome, with or without further processing of the outcome, as at least part of a reply to the request. To that end, a cloud computing, distributed computing, mobile edge computing (MEC), or client-server computing technology may be used, for example. The electronic device 1001 may provide ultra low-latency services using, e.g., distributed computing or mobile edge computing. In another embodiment, the external electronic device 1004 may include an internet-of-things (IoT) device. The server 1008 may be an intelligent server using machine learning and/or a neural network. According to an embodiment, the external electronic device 1004 or the server 1008 may be included in the second network 1099. The electronic device 1001 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1040) including one or more instructions that are stored in a storage medium (e.g., internal memory 1036 or external memory 1038) that is readable by a machine (e.g., the electronic device 1001). For example, a processor (e.g., the processor 1020) of the machine (e.g., the electronic device 1001) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

In response identification of an event, a method for changing a sequence of a post-processing function with respect to images may be required. As described above, according to an embodiment, an electronic device (e.g., the electronic device 101 of FIG. 1 and/or the electronic device 1001 of FIG. 10) may comprise a display (e.g., the display 240 of FIG. 2), memory (e.g., the memory 220 of FIG. 2) storing instructions, and a processor (e.g., the processor 210 of FIG. 2 and/or the processor 1020 of FIG. 10). The instructions, when executed by the processor, may cause the electronic device to identify, in response to identifying an input indicating a selection of a first image (e.g., the second image 122 of FIG. 1) through the display, a sequence for execution of a post-processing function. The instructions, when executed by the processor, may cause the electronic device to change, based on identifying the first image and a second image (e.g., the fourth image 124 of FIG. 1) positioned before the first image in the sequence, a position of the first image within the sequence. The instructions, when executed by the processor, may cause the electronic device to display, based on executing a post-processing function with respect to the first image in accordance with the changed position, the first image changed by the post-processing function in the display.

According to an embodiment, the instructions, when executed by the processor, may cause the electronic device to change, based on identifying the first image and the second image positioned before the first image in the sequence, a position of the first image within the sequence to a position before a position of the second image within the sequence.

According to an embodiment, the instructions, when executed by the processor, may cause the electronic device to execute a post-processing function with respect to the first image before executing a post-processing function with respect to the second image based on changed positions within the sequence.

According to an embodiment, the first image may include a group of a plurality of sub-images captured by a shooting input.

According to an embodiment, the post-processing function may include at least one of high dynamic range (HDR), portrait, low light shot (LLS), night mode adjustment, resolution adjustment, image filtering, and noise adjustment.

According to an embodiment, the instructions, when executed by the processor, may cause the electronic device to change, based on identifying a third image having relatively more pixels than pixels of the first image and the second image, a position of the third image to a position after the second image.

According to an embodiment, the instructions, when executed by the processor, may cause the electronic device to execute, based on termination of an application for obtaining the images, a post-processing function of the third image.

According to an embodiment, the instructions, when executed by the processor, may cause the electronic device to change, based on a state of a hardware component included in the electronic device, positions of the first image and the second image.

As described above, according to an embodiment, a method of an electronic device may comprise identifying, in response to identifying an input indicating a selection of a first image through a display, a sequence for execution of a post-processing function. The method may comprise changing, based on identifying the first image and a second image positioned before the first image in the sequence, a position of the first image within the sequence. The method may comprise displaying, based on executing a post-processing function with respect to the first image in accordance with the changed position, the first image changed by the post-processing function in the display.

According to an embodiment, the method may comprise changing, based on identifying the first image and the second image positioned before the first image in the sequence, a position of the first image within the sequence to a position before a position of the second image within the sequence.

According to an embodiment, the method may comprise executing a post-processing function with respect to the first image before executing a post-processing function with respect to the second image based on changed positions within the sequence.

According to an embodiment, the method may comprise executing a post-processing function with respect to the first image before executing a post-processing function with respect to the second image based on changed positions within the sequence.

According to an embodiment, the first image may include a group of a plurality of sub-images captured by a shooting input.

According to an embodiment, the post-processing function may include at least one of high dynamic range (HDR), portrait, low light shot (LLS), night mode adjustment, resolution adjustment, image filtering, and noise adjustment.

According to an embodiment, the method may comprise changing, based on identifying a third image having relatively more pixels than pixels of the first image and the second image, a position of the third image to a position after the second image.

According to an embodiment, the method may comprise executing, based on termination of an application for obtaining the images, a post-processing function of the third image.

According to an embodiment, the method may comprise changing, based on a state of a hardware component included in the electronic device, positions of the first image and the second image.

As described above, according to an embodiment, in a computer readable storage medium storing one or more programs, the one or more programs, when executed by a processor of an electronic device, may cause the processor of the electronic device to identify, in response to identifying an input indicating a selection of a first image through a display, a sequence for execution of a post-processing function. The one or more programs, when executed by the processor of the electronic device, may cause the processor of the electronic device to change, based on identifying the first image and a second image positioned before the first image in the sequence, a position of the first image within the sequence. The one or more programs, when executed by the processor of the electronic device, may cause the processor of the electronic device to display, based on executing a post-processing function with respect to the first image in accordance with the changed position, the first image changed by the post-processing function in the display.

According to an embodiment, the one or more programs, when executed by the processor of the electronic device, may cause the processor of the electronic device to change, based on identifying the first image and the second image positioned before the first image in the sequence, a position of the first image within the sequence to a position before a position of the second image within the sequence.

According to an embodiment, the one or more programs, when executed by the processor of the electronic device, may cause the processor of the electronic device to execute a post-processing function with respect to the first image before executing a post-processing function with respect to the second image based on changed positions within the sequence.

According to an embodiment, the first image may include a group of a plurality of sub-images captured by a shooting input.

According to an embodiment, the post-processing function may include at least one of high dynamic range (HDR), portrait, low light shot (LLS), night mode adjustment, resolution adjustment, image filtering, and noise adjustment.

According to an embodiment, the one or more programs, when executed by the processor of the electronic device, may cause the processor of the electronic device to change, based on identifying a third image having relatively more pixels than pixels of the first image and the second image, a position of the third image to a position after the second image.

According to an embodiment, the one or more programs, when executed by the processor of the electronic device, may cause the processor of the electronic device to execute, based on termination of an application for obtaining the images, a post-processing function of the third image.

According to an embodiment, the one or more programs, when executed by the processor of the electronic device, may cause the processor of the electronic device to change, based on a state of a hardware component included in the electronic device, positions of the first image and the second image.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

No claim element is to be construed under the provisions of 35 U.S.C. § 112, sixth paragraph, unless the element is expressly recited using the phrase “means for” or “means.”

What is claimed is:

1. An electronic device comprising:
a display;
memory storing instructions; and
one or more processors,
wherein the instructions, when executed by the one or more processors individually or collectively, cause the electronic device to:
identify, in response to identifying an input indicating a selection of a first image through the display, a sequence for execution of a post-processing function,
change, based on identifying the first image and a second image positioned before the first image in the sequence, a position of the first image within the sequence, and
display, based on executing a post-processing function with respect to the first image in accordance with the changed position, the first image changed by the post-processing function in the display.

2. The electronic device of claim 1, wherein the instructions, when executed by the one or more processors individually or collectively, cause the electronic device to:
change, based on identifying the first image and the second image positioned before the first image in the sequence, a position of the first image within the sequence to a position before a position of the second image within the sequence.

3. The electronic device of claim 1, wherein the instructions, when executed by the one or more processors individually or collectively, cause the electronic device to:
execute a post-processing function with respect to the first image before executing a post-processing function with respect to the second image based on changed positions within the sequence.

4. The electronic device of claim 1, wherein the first image includes a group of a plurality of sub-images captured by a shooting input.

5. The electronic device of claim 1, wherein the post-processing function includes at least one of high dynamic range (HDR), portrait, low light shot (LLS), night mode adjustment, resolution adjustment, image filtering, and noise adjustment.

6. The electronic device of claim 1, wherein the instructions, when executed by the one or more processors individually or collectively, cause the electronic device to:
change, based on identifying a third image having relatively more pixels than pixels of the first image and the second image, a position of the third image to a position after the second image.

7. The electronic device of claim 6, wherein the instructions, when executed by the one or more processors individually or collectively, cause the electronic device to:
execute, based on termination of an application for obtaining the images, a post-processing function of the third image.

8. The electronic device of claim 7, wherein the instructions, when executed by the one or more processors individually or collectively, cause the electronic device to:
change, based on a state of a hardware component included in the electronic device, positions of the first image and the second image.

9. A method performed by an electronic device, comprising:
identifying, in response to identifying an input indicating a selection of a first image through a display, a sequence for execution of a post-processing function;
changing, based on identifying the first image and a second image positioned before the first image in the sequence, a position of the first image within the sequence; and
displaying, based on executing a post-processing function with respect to the first image in accordance with the changed position, the first image changed by the post-processing function in the display.

10. The method of claim 9, comprising:
changing, based on identifying the first image and the second image positioned before the first image in the sequence, a position of the first image within the sequence to a position before a position of the second image within the sequence.

11. The method of claim 9, comprising:
executing a post-processing function with respect to the first image before executing a post-processing function with respect to the second image based on changed positions within the sequence.

12. The method of claim 9, wherein the first image includes a group of a plurality of sub-images captured by a shooting input.

13. The method of claim 9, wherein the post-processing function includes at least one of high dynamic range (HDR), portrait, low light shot (LLS), night mode adjustment, resolution adjustment, image filtering, and noise adjustment.

14. The method of claim 9, comprising:
changing, based on identifying a third image having relatively more pixels than pixels of the first image and the second image, a position of the third image to a position after the second image.

15. The method of claim 9, comprising:
executing, based on termination of an application for obtaining the images, a post-processing function of a third image.

16. The method of claim 15, comprising:
changing, based on a state of a hardware component included in the electronic device, positions of the first image and the second image.

17. One or more non-transitory computer readable storage media storing one or more programs including computer-executable instructions that, when executed by one or more processors individually or collectively, cause an electronic device to perform operations, the operations comprising:
identifying, in response to identifying an input indicating a selection of a first image through a display, a sequence for execution of a post-processing function;
changing, based on identifying the first image and a second image positioned before the first image in the sequence, a position of the first image within the sequence; and
displaying, based on executing a post-processing function with respect to the first image in accordance with the changed position, the first image changed by the post-processing function in the display.

18. The one or more non-transitory computer readable storage media of claim 17, the operations further comprising:
changing, based on identifying the first image and the second image positioned before the first image in the sequence, a position of the first image within the sequence to a position before a position of the second image within the sequence.

19. The one or more non-transitory computer readable storage media of claim 17, the operations further comprising:
execute a post-processing function with respect to the first image before executing a post-processing function with respect to the second image based on changed positions within the sequence.

20. The one or more non-transitory computer readable storage media of claim 17, wherein the first image includes a group of a plurality of sub-images captured by a shooting input.
